(19) United States
(12) Patent Application Publication
(10) Pub. No.: US 2023/0224655 A1
(43) Pub. Date: Jul. 13, 2023

(54) Failure Diagnosing Method, Noise Measuring Device, And Failure Diagnosing System

(71) Applicant: Nihon Onkyo Engineering Co., Ltd., Tokyo (JP)

(72) Inventors: Hosei Kawagoe, Tokyo (JP); Etsushi Fujita, Tokyo (JP); Osamu Kohashi, Tokyo (JP); Yoshio Tadahira, Tokyo (JP); Shigeki Sugaya, Tokyo (JP); Takahiro Mizuno, Tokyo (JP); Shozo Suido, Tokyo (JP); Shinji Ohashi, Tokyo (JP)

(73) Assignee: Nihon Onkyo Engineering Co., Ltd., Tokyo (JP)

(21) Appl. No.: 18/010,631

(22) PCT Filed: Jun. 28, 2021
(86) PCT No.: PCT/JP2021/024282

§ 371 Date: Dec. 15, 2022

(30) Foreign Application Priority Data
Jun. 29, 2020 (JP) 2020-111600

(51) Int. Cl. H04R 29/00; H04R 1/08; H04R 1/40; H04R 3/00

(52) U.S. Cl. CPC H04R 29/005; H04R 1/086; H04R 1/406; H04R 3/005

(57) ABSTRACT

A time at which a failure of a noise level meter has occurred is accurately determined. The present invention relates to a noise measuring device including a noise level meter having a main microphone capable of measuring noise, and a sub microphone capable of measuring noise at the same time as the main microphone. The present invention also relates to a failure diagnosing system having the noise measuring device and a failure diagnosing device capable of diagnosing a failure of the main microphone. The present invention also relates to a failure diagnosing method for diagnosing a failure of the main microphone. In the failure diagnosing system and the method, the presence or absence of a failure of the main microphone in the noise level meter is diagnosed based on the comparison between main and sub noise data obtained by the main and sub microphones and respectively in each of a plurality of recording periods.

### TECHNICAL FIELD

The present invention relates to a failure diagnosing method for diagnosing a failure of a microphone. Furthermore, the present invention relates to a noise measuring device including a noise level meter having a microphone, and also relates to a failure diagnosing system capable of diagnosing a failure of a microphone of a noise level meter.

### BACKGROUND ART

Noise level meters each having a microphone are used for various purposes such as monitoring of noise pollution and noise comfort design. For example, in order to continuously monitor the noise of airplanes around airfields, noise level meters are installed around the airfields in local governments and the like, and noise data which are continuously measured by the noise level meters are recorded and managed.

### SUMMARY OF INVENTION

### Technical Problem

When a noise level meter continuously measures noise as described above, periodic inspection is generally conducted on the noise level meter at regular intervals such as a semi-annual cycle or a one-year cycle. However, for example, in the case of periodic inspections of a semi-annual cycle, when no failure occurred in the noise level meter in a certain periodic inspection, but a failure of the noise level meter, especially a failure of a microphone has occurred in the next periodic inspection six months later, it is unclear at what time in the six months between these periodic inspections the failure occurred.

In this case, since all of the noise data which have been continuously measured by the noise level meter during these last six months may be affected by the failure, there is a risk that all of these noise data may be unavailable. On the other hand, if it is possible to know at what time between the periodic inspections before and after the failure, the failure of the noise level meter, especially the failure of the microphone, occurred, it can be determined that the noise data, from the time of the periodic inspection conducted before the failure of the noise level meter occurred, until the occurrence of the failure of the noise level meter, are not affected by the failure, and can be used.

In view of such circumstances, it is desired that the time at which the failure of the noise level meter occurs can be accurately determined in a failure diagnosing method for diagnosing failure of the noise level meter. In particular, it is desired in the failure diagnosing method that the time at which the failure of the noise level meter occurs can be accurately determined without conducting a physical inspection of the actual body of the noise level meter.

Furthermore, in a noise measuring device having a noise level meter and a failure diagnosing system for diagnosing a failure of a noise level meter, it is desired to accurately determine the time at which the failure of the noise level meter occurs. In particular, in the noise measuring device and the failure diagnosing system, it is desired that the time at which a failure of the noise level meter occurs can be accurately determined without conducting a physical inspection of the actual body of the noise level meter.

### Solution to Problem

In order to solve the above problem, a failure diagnosing method according to an aspect is a failure diagnosing method for diagnosing a failure of a main microphone, and comprises a recording step of recording main noise data based on noise measured by the main microphone and sub noise data based on noise measured by a sub microphone simultaneously with the measurement of the noise by the main microphone in each of a plurality of different recording periods according to elapse of time, and a failure diagnosis step of diagnosing presence or absence of a failure of the main microphone in each recording period based on a noise comparison for comparing the main and sub noise data recorded in the recording period.

A noise measuring device according to an aspect comprises a noise level meter including a main microphone configured to be capable of measuring noise, and a sub microphone configured to be capable of measuring noise simultaneously with the measurement of the noise by the main microphone in order to obtain sub noise data to be compared with main noise data obtained based on the noise measured by the main microphone.

A failure diagnosing system according to an aspect comprises the above noise measuring device, and a failure diagnosing device configured to be capable of diagnosing a failure of the main microphone of the noise level meter, wherein the failure diagnosing device is configured to be capable of diagnosing presence or absence of a failure of the main microphone in each of a plurality of different recording periods according to elapse of time based on noise comparison for comparing the main and sub noise data recorded in the recording period.

### Advantageous Effects of Invention

In the failure diagnosing method according to an aspect, the time at which the failure of the noise level meter has occurred can be accurately determined. In particular, in the failure diagnosing method according to the aspect, it is possible to accurately determine the time at which the failure of the noise level meter has occurred without conducting a physical inspection of the actual body of the noise level meter.

In the noise measuring device and the failure diagnosing system according to the aspect, it is possible to accurately determine the time at which the failure of the noise level meter has occurred. In particular, in the noise measuring device and the failure diagnosing system according to the aspect, it is possible to accurately determine the time at which the failure of the noise level meter has occurred without conducting a physical inspection of the actual body of the noise level meter.

### BRIEF DESCRIPTION OF DRAWINGS

FIG. 1 is a block diagram of a failure diagnosing system according to an embodiment.

FIG. 2 is an exploded perspective view schematically showing a state in which a noise level meter and a sub microphone of a noise measuring device according to the embodiment are disassembled.

FIG. 3 is a perspective view schematically showing the noise level meter and the sub microphone of the noise measuring device according to the embodiment in a state in which a part of a windscreen and a cover are omitted.

FIG. 4A is a graph showing a comparison result between main and sub noise data based on noise including event noise in a state in which the sensitivity of a main microphone is reduced by 0.5 dB with respect to the sensitivity of a sub microphone in a first example of the embodiment and an Example 1, and a graph showing main and sub noise waveforms which respectively represent noise levels of the main and sub noise data on a time axis.

FIG. 4B is a graph showing a comparison result between main and sub noise data based on noise including event noise in a state in which the sensitivity of the main microphone is reduced by 0.5 dB with respect to the sensitivity of the sub microphone in the first example of the embodiment and the Example 1, and a graph showing the difference of the noise levels of the main and sub noise data in a plurality of frequency bands and at the overall value.

FIG. 4C is a graph showing a comparison result between main and sub noise data based on noise including event noise in a state in which the sensitivity of the main microphone is reduced by 0.5 dB with respect to the sensitivity of the sub microphone in the first example of the embodiment and the Example 1, and a graph showing MSC (magnitude-squared coherence) values based on the noise levels of the main and sub noise data in a plurality of frequency bands and at the overall value.

FIG. 5A a graph showing a comparison result between main and sub noise data based on noise including event noise in a state in which the sensitivity of a main microphone is reduced by 1.0 dB with respect to the sensitivity of a sub microphone in a second example of the embodiment and an Example 2, and a graph showing main and sub noise waveforms which respectively represent noise levels of the main and sub noise data on the time axis.

FIG. 5B is a graph showing a comparison result between main and sub noise data based on noise including event noise in a state in which the sensitivity of the main microphone is reduced by 1.0 dB with respect to the sensitivity of the sub microphone in the second example of the embodiment and the Example 2, and a graph showing the difference of the noise levels of the main and sub noise data in a plurality of frequency bands and at the overall value.

FIG. 5C is a graph showing a comparison result between main and sub noise data based on noise including event noise in a state in which the sensitivity of the main microphone is reduced by 1.0 dB with respect to the sensitivity of the sub microphone in the second example of the embodiment and the Example 2, and a graph showing MSC values based on the noise levels of the main and sub noise data in a plurality of frequency bands and at the overall value.

FIG. 6A a graph showing a comparison result between main and sub noise data based on noise including event noise in a state in which the sensitivity of a main microphone is reduced by 1.5 dB with respect to the sensitivity of a sub microphone in a third example of the embodiment and an Example 3, and a graph showing main and sub noise waveforms which respectively represent noise levels of the main and sub noise data on the time axis.

FIG. 6B is a graph showing a comparison result between main and sub noise data based on noise including event noise in a state in which the sensitivity of the main microphone is reduced by 1.5 dB with respect to the sensitivity of the sub microphone in the third example of the embodiment and the Example 3, and a graph showing the difference of the noise levels of the main and sub noise data in a plurality of frequency bands and at the overall value.

FIG. 6C is a graph showing a comparison result between main and sub noise data based on noise including event noise in a state in which the sensitivity of the main microphone is reduced by 1.5 dB with respect to the sensitivity of the sub microphone in the third example of the embodiment and the Example 3, and a graph showing MSC values based on the noise levels of the main and sub noise data in a plurality of frequency bands and at the overall value.

FIG. 7A a graph showing a comparison result between main and sub noise data based on noise including event noise in a state in which the sensitivity of a main microphone is reduced by 2.0 dB with respect to the sensitivity of a sub microphone in a fourth example of the embodiment and an Example 4, and a graph showing main and sub noise waveforms which respectively represent noise levels of the main and sub noise data on the time axis.

FIG. 7B is a graph showing a comparison result between main and sub noise data based on noise including event noise in a state in which the sensitivity of the main microphone is reduced by 2.0 dB with respect to the sensitivity of the sub microphone in the fourth example of the embodiment and the Example 4, and a graph showing the difference of the noise levels of the main and sub noise data in a plurality of frequency bands and at the overall value.

FIG. 7C is a graph showing a comparison result between main and sub noise data based on noise including event noise in a state in which the sensitivity of the main microphone is reduced by 2.0 dB with respect to the sensitivity of the sub microphone in the fourth example of the embodiment and the Example 4, and a graph showing MSC values based on the noise levels of the main and sub noise data in a plurality of frequency bands and at the overall value.

FIG. 8A a graph showing a comparison result between main and sub noise data based on noise including event noise in a state in which the sensitivity of a main microphone is reduced by 2.5 dB with respect to the sensitivity of a sub microphone in a fifth example of the embodiment and an Example 5, and a graph showing main and sub noise waveforms which respectively represent noise levels of the main and sub noise data on the time axis.

FIG. 8B is a graph showing a comparison result between main and sub noise data based on noise including event noise in a state in which the sensitivity of the main microphone is reduced by 2.5 dB with respect to the sensitivity of the sub microphone in the fifth example of the embodiment and the Example 5, and a graph showing the difference of the noise levels of the main and sub noise data in a plurality of frequency bands and at the overall value.

FIG. 8C is a graph showing a comparison result between main and sub noise data based on noise including event noise in a state in which the sensitivity of the main microphone is reduced by 2.5 dB with respect to the sensitivity of the sub microphone in the fifth example of the embodiment and the Example 5, and a graph showing MSC values based on the noise levels of the main and sub noise data in a plurality of frequency bands and at the overall value.

FIG. 9A is a graph showing a comparison result between main noise data including noise caused by a failure and sub noise data including no noise caused by a failure in a sixth example of the embodiment and an Example 6, and a graph showing main and sub noise waveforms which respectively represent noise levels of main and sub noise data on the time axis.

FIG. 9B is a graph showing a comparison result between main noise data including noise caused by a failure and sub noise data including no noise caused by a failure in the sixth example of the embodiment and the Example 6, and a graph showing the difference of the noise levels of the main and sub noise data in a plurality of frequency bands and at the overall value.

FIG. 9C is a graph showing a comparison result between main noise data including noise caused by a failure and sub noise data including no noise caused by a failure in the sixth example of the embodiment and the Example 6, and a graph showing MSC values based on the noise levels of the main and sub noise data in a plurality of frequency bands and at the overall value.

FIG. 10A is a graph showing a comparison result between main and sub noise data based on background noise in a state in which the same pink noise of 50 dB is added to each of noises measured by main and sub microphones in a seventh example of the embodiment and an Example 7, and a graph showing main and sub noise waveforms which respectively represent noise levels of the main and sub noise data on the time axis.

FIG. 10B is a graph showing a comparison result between main and sub noise data based on background noise in a state in which the same pink noise of 50 dB is added to each of the noises measured by the main and sub microphones in the seventh example of the embodiment and an Example 7, and a graph showing the difference of the noise levels of the main and sub noise data in a plurality of frequency bands and at the overall value.

FIG. 10C is a graph showing a comparison result between main and sub noise data based on background noise in a state in which the same pink noise of 50 dB is added to each of the noises measured by the main and sub microphones in the seventh example of the embodiment and the Example 7, and a graph showing MSC values based on the noise levels of the main and sub noise data in a plurality of frequency bands and at the overall value.

FIG. 11A is a graph showing a comparison result between main and sub noise data based on background noise in a state in which different pink noises of 60 dB are added to each of noises measured by main and sub microphones in an eighth example of the embodiment and an Example 8, and a graph showing main and sub noise waveforms which respectively represent noise levels of the main and sub noise data on the time axis.

FIG. 11B is a graph showing a comparison result between main and sub noise data based on background noise in a state in which different pink noises of 60 dB are added to each of the noises measured by the main and sub microphones in the eighth example of the embodiment and the Example 8, and a graph showing the difference of the noise levels of the main and sub noise data in a plurality of frequency bands and at the overall value.

FIG. 11C is a graph showing a comparison result between main and sub noise data based on background noise in a state in which different pink noises of 60 dB are added to each of the noises measured by the main and sub microphones in the eighth example of the embodiment and the Example 8, and a graph showing MSC values based on the noise levels of the main and sub noise data in a plurality of frequency bands and at the overall value.

FIG. 12 is a flowchart showing an outline of a failure diagnosing method according to an embodiment.

FIG. 13 is a flowchart showing an example of a failure diagnosing process of the failure diagnosing method according to the embodiment.

### DESCRIPTION OF EMBODIMENTS

A noise measuring device according to an embodiment, a failure diagnosing system having the same, and a failure diagnosing method will be described below.

### Outline of Noise Measuring Device and Failure Diagnosing System

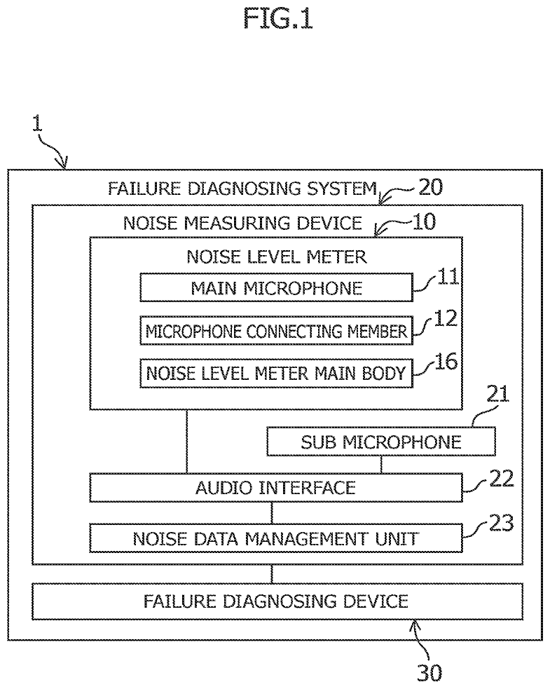

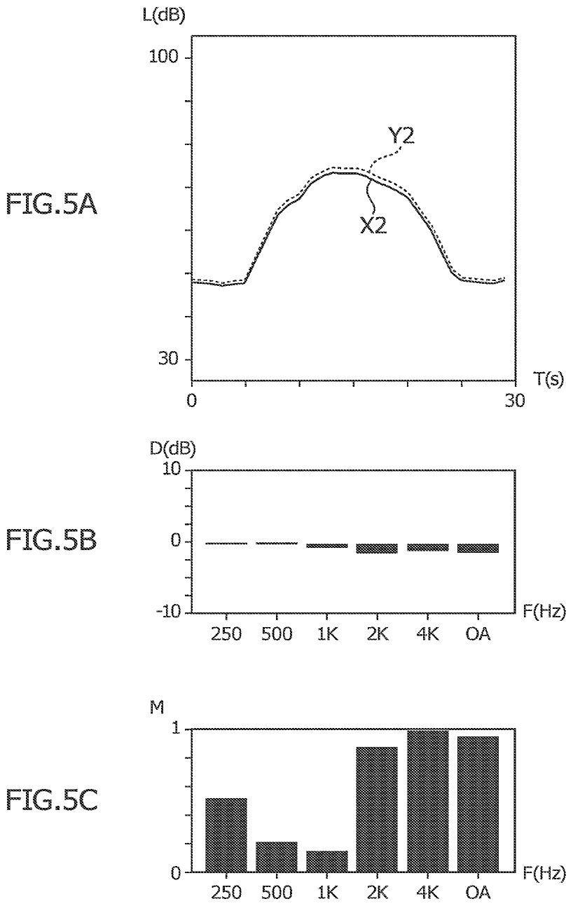

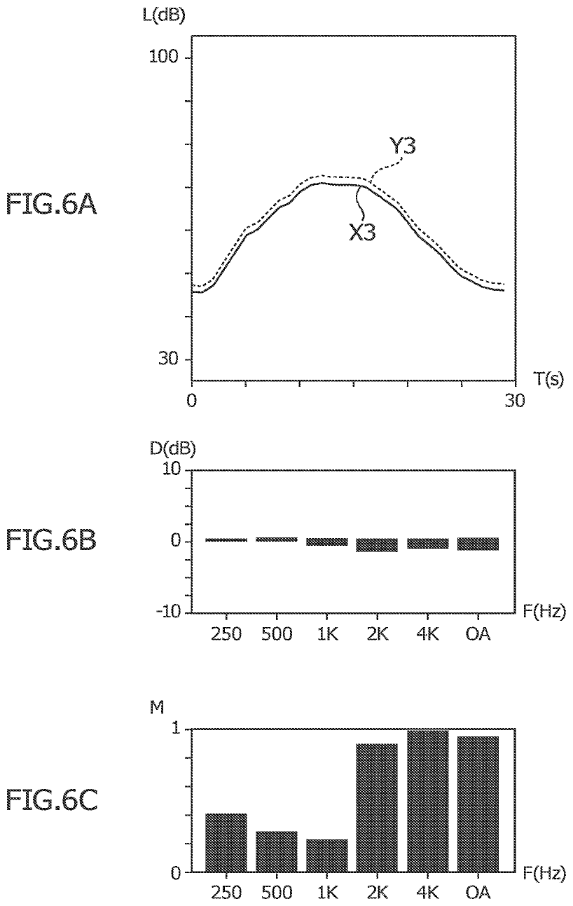

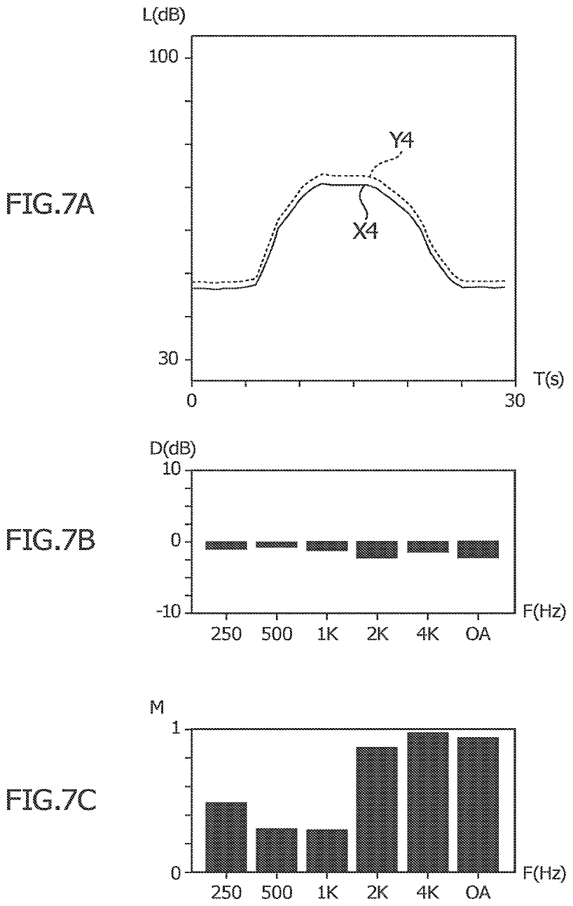

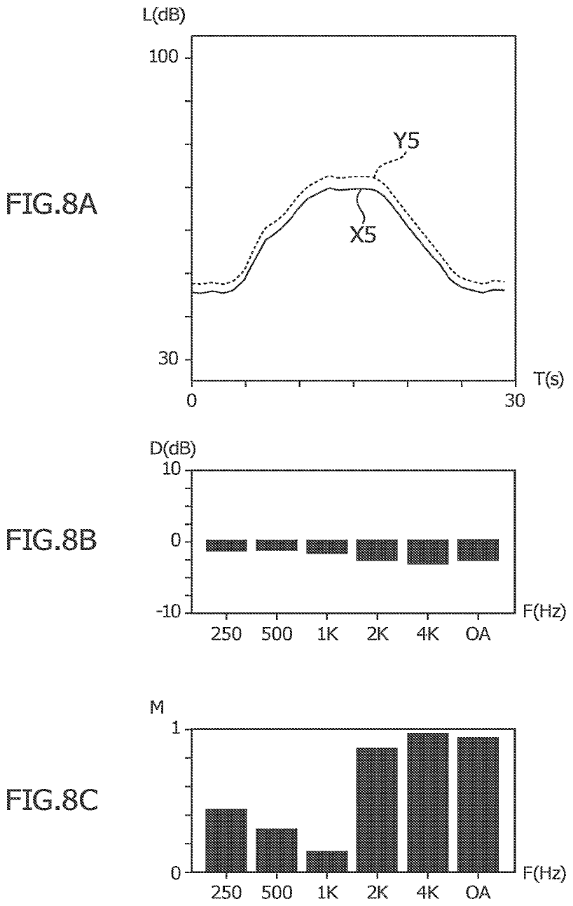

The outline of a noise measuring device 20 and a failure diagnosing system 1 according to the present embodiment will be described with reference to FIGS. 1 to 11C. The noise measuring device 20 and the failure diagnosing system 1 according to the present embodiment are generally configured as follows.

As shown in FIG. 1, the failure diagnosing system 1 includes a noise level meter 10 having a main microphone 11 configured to be capable of measuring noise. Furthermore, the failure diagnosing system 1 includes a noise measuring device 20 having such a noise level meter 10. As shown in FIGS. 1 to 3, the noise measuring device 20 includes a sub microphone 21 configured to be capable of measuring noise simultaneously with the measurement of noise by the main microphone 11 in order to obtain sub noise data to be compared with main noise data obtained based on the noise measured by the main microphone 11.

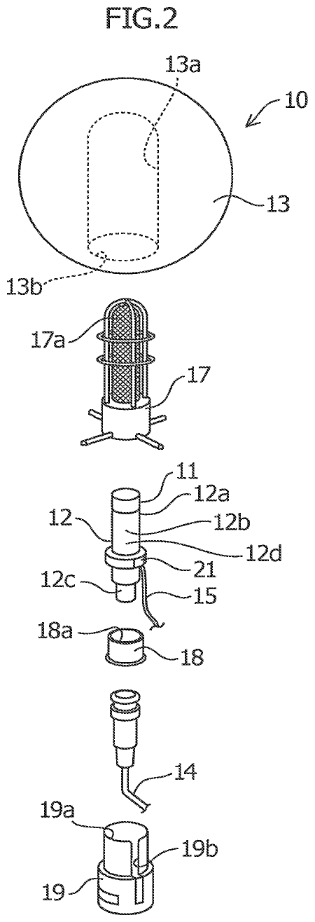

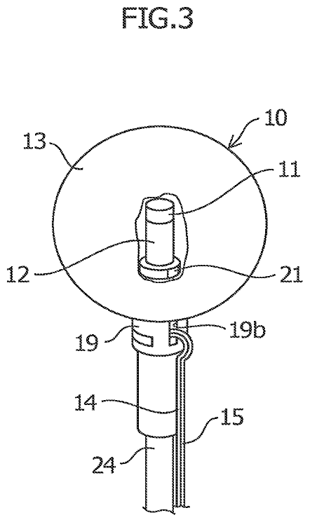

Furthermore, the noise measuring device 20 and the failure diagnosing system 1 according to the present embodiment can be generally configured as follows. As shown in FIGS. 2 and 3, the noise level meter 10 includes a microphone connecting member 12 formed in an elongated shape. The main microphone 11 is arranged at a tip portion 12a in the longitudinal direction of the microphone connecting member 12. The sub microphone 21 is arranged on the outer peripheral surface 12b of the microphone connecting member 12.

The noise level meter 10 includes a windscreen 13. The main and sub microphones 11 and 21 are arranged inside the windscreen 13. However, the main microphone may be arranged inside the windscreen while the sub microphone is arranged outside the windscreen. In this case, the sub microphone can be arranged inside another windscreen.

It is preferable that the sub microphone 21 be installed so that the sub noise data obtained by the sub microphone 21 is made as equal as possible to the main noise data obtained by the main microphone 11. It is preferable that the correlation of the main and sub noise data, which are required to be as equal as possible in this way, be determined to the extent that the failure of the main microphone 11 can be diagnosed.

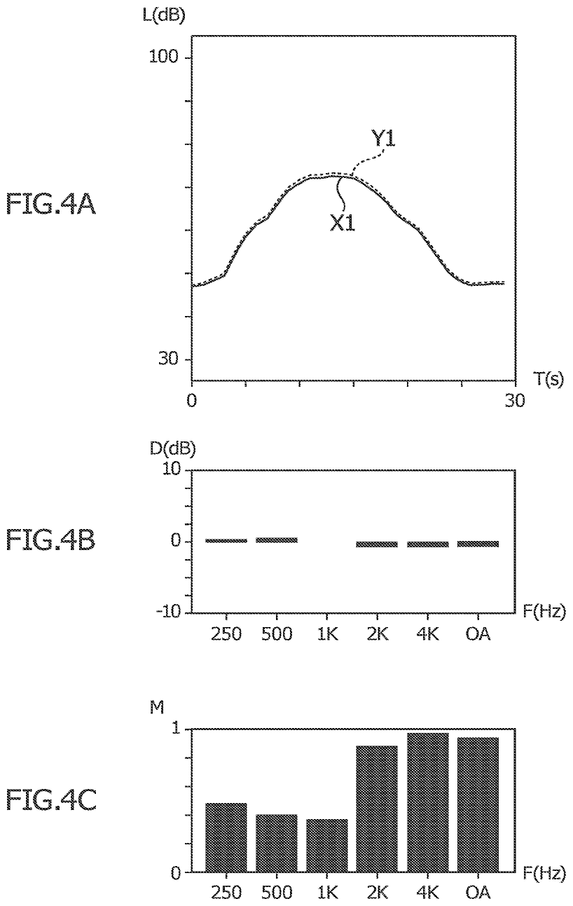

As shown in FIG. 1, the failure diagnosing system 1 also includes a failure diagnosing device 30 configured to be capable of diagnosing a failure of the main microphone 11 of the noise level meter 10. As shown in FIGS. 4A to 11A, FIGS. 4B to 11B, and FIGS. 4C to 11C, the failure diagnosing device 30 is configured to be capable of diagnosing the presence or absence of a failure of the main microphone 11 in each of a plurality of different recording periods based on a noise comparison for comparing main and sub noise data recorded in the recording period according to elapse of time.

Referring to FIGS. 4A to 11A, in the failure diagnosing device 30, the noise comparison described above includes a time-noise comparison for comparing a main noise waveform and a sub noise waveform which respectively represent the noise levels based on noise measured by the main and sub microphones 11 and 21, respectively, on a time axis. Referring to FIGS. 4B to 11B and FIGS. 4C to 11C, in the failure diagnosing device 30, the noise comparison described above includes a frequency-noise comparison for comparing the noise levels based on the noise measured by the main and sub microphones 11 and 21, respectively, on a frequency axis. The details of FIGS. 4A to 11C will be described later.

Referring to FIGS. 4B to 11B, the failure diagnosing device 30 as described above diagnoses that the main microphone 11 has a failure in the case in which in the time-noise comparison, the main noise waveform includes an event pulse waveform having a noise level greater than that of a background noise, whereas the sub noise waveform includes an event pulse waveform having a noise level greater than that of the background noise at the same time as the event pulse waveform of the main noise waveform, and in the frequency-noise comparison, the absolute value d of the difference between the noise levels based on the event pulse waveforms of the main and sub noise waveforms is greater than a predetermined noise difference threshold value d1 in at least one of a plurality of frequency bands, and/or at the overall value.

The noise difference threshold value d1 can be set according to the amount of change in sensitivity which is determined as a determination material for diagnosing a failure of the main microphone 11. For example, the noise difference threshold value d1 can be set to increase as the amount of change in sensitivity determined as a determination material for diagnosing a failure of the main microphone 11 increases. For example, the noise difference threshold value d1 can be set to 0.5 dB, 1.0 dB, 1.5 dB, 2.0 dB, and 2.5 dB when the amount of change in the sensitivity described above is equal to ±0.5 dB, ±1.0 dB, ±1.5 dB, ±2.0 dB, and ±2.5 dB, respectively. However, the noise difference threshold value is not limited to these values.

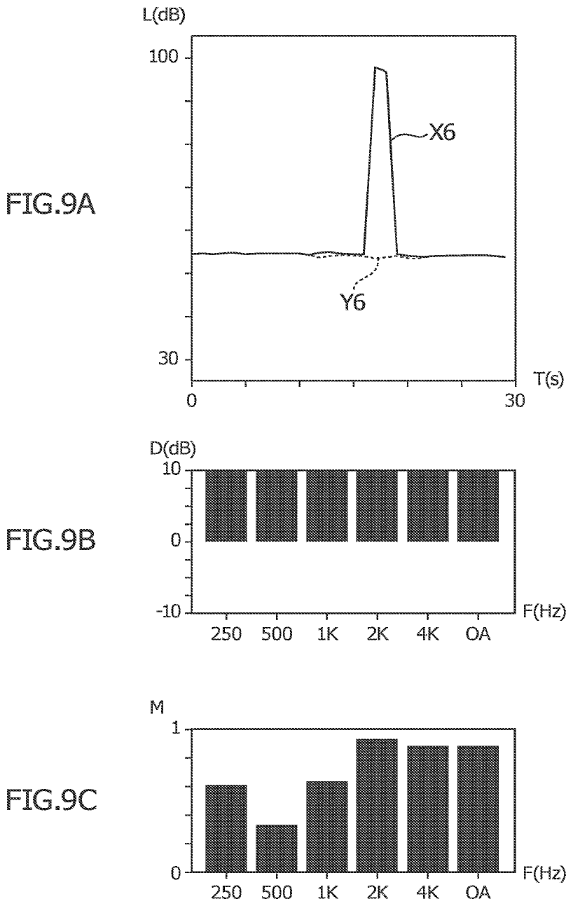

Referring to FIG. 9A, the failure diagnosing device 30 diagnoses that the main microphone 11 has a failure when the main noise waveform includes an impact pulse waveform of which noise level is increased more than that of the sub noise waveform at a specific pulse width in the time-noise comparison. The pulse width of the impact pulse waveform is preferably in the range of 0.1 second to 2.0 seconds.

Examples of the impact pulse waveform include an impact pulse waveform caused by noise or the like occurring when a failure occurs in the main microphone 11, etc. In particular, the impact pulse waveform caused by noise occurring when a failure occurs in the main microphone 11 tends to be a pulse waveform that increases the noise level at the above pulse width. The minimum value of the pulse width of the impact pulse waveform can be determined based on the fact that the period of the equivalent noise level can be set to 0.1 second at the minimum. The maximum value of the pulse width of the impact pulse waveform can be determined based on the tendency that the pulse width of noise which momentarily occurs when the main microphone 11 fails is equal to 2 seconds or less.

Furthermore, the pulse width of the impact pulse waveform caused by noise occurring when a failure occurs in the main microphone 11 remarkably tends to be equal to about 1.0 second. Based on such a remarkable tendency, in order to identify noise occurring when a failure occurs in the main microphone 11, the minimum value of the pulse width of the impact pulse waveform can be set to 0.5 seconds, preferably 0.7 seconds, more preferably 0.8 seconds, and further more preferably 0.9 seconds. Furthermore, the maximum value of such a pulse width can be set to 1.5 seconds, preferably 1.3 seconds, more preferably 1.2 seconds, and further more preferably 1.1 seconds.

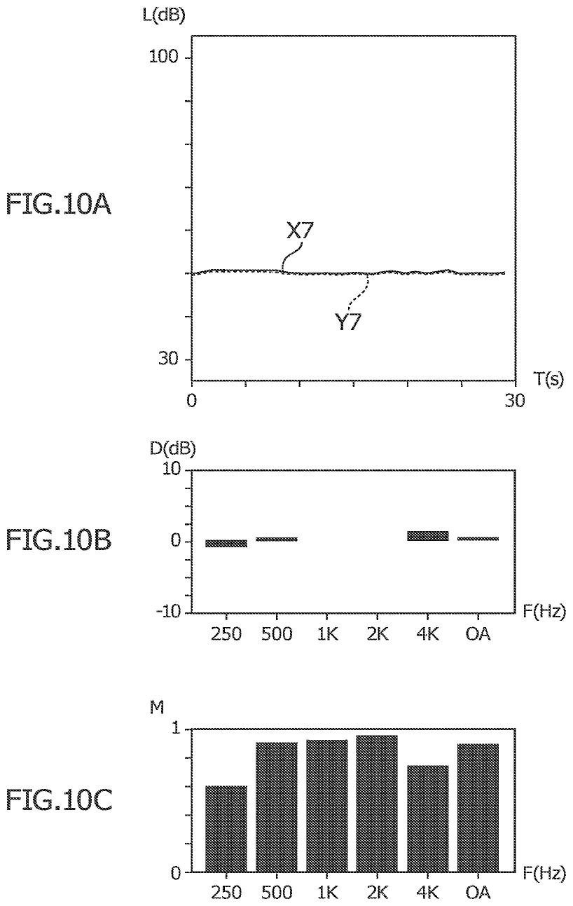

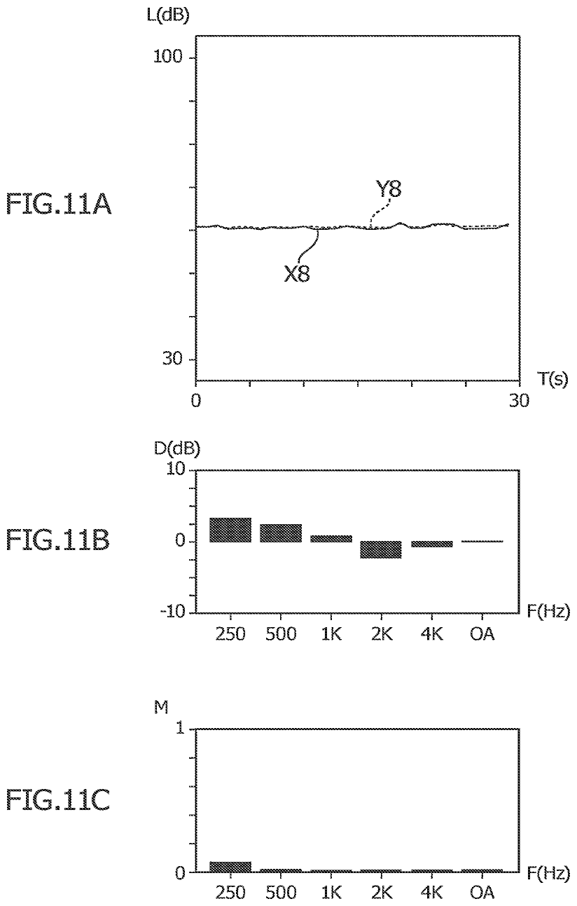

Referring to FIGS. 10C and 11C, the failure diagnosing device 30 diagnoses that the main microphone 11 has a failure when an MSC value m calculated from noise data based on background noises measured by the main and sub microphones 11 and 21 respectively in at least one of a plurality of frequency bands, and/or at the overall value in the frequency-noise comparison is smaller than a predetermined coherence threshold value m1.

For example, the coherence threshold value m1 can be set in consideration of the variation of the MSC value m calculated from the noise data based on the background noises confirmed by the main and sub microphones 11 and 21 in the normal state, respectively. For example, the coherence threshold value m1 can be set to 0.2. However, the coherence threshold value is not limited to this value. For example, the coherence threshold value can be set within a range of 0.1 to 0.9 as appropriate.

In the present embodiment, the MSC value m is calculated as follows.
(1) A main audio signal of the main microphone 11 and a sub audio signal of the sub microphone 21 are divided by a predetermined frame length on the time axis.
(2) By using a fast Fourier transform or the like, the average values of the power spectra of the main and sub audio signals in all the divided frames and the average value of the cross spectra between the main and sub audio signals are calculated.
(3) In each frequency band, the energy sum A of the power spectrum average value of the main audio signal, the energy sum B of the power spectrum average value of the sub audio signal, and the energy sum C of the absolute value of the cross spectrum average value are calculated.
(4) In each frequency band, based on the following (Equation 1), the MSC value is calculated from the energy sum A of the power spectrum average value of the main audio signal, the energy sum B of the power spectrum average value of the sub audio signal, and the energy sum C of the absolute value of the cross spectrum average value.

MSC value=C²/(A×B) (Equation 1)

Here, FIGS. 4A to 11A are graphs shown as first to eighth examples of the present embodiment, respectively. In each of FIGS. 4A to 11A, solid lines X1 to X8 indicate main noise waveforms, broken lines Y1 to Y8 indicate sub noise waveforms, the vertical axis L represents an equivalent noise level (dB), and the horizontal axis T represents the time (s (seconds)). In particular, each of FIGS. 4A to 11A shows main and sub noise waveforms which respectively represent equivalent noise levels (LAeq, 1 s) of main and sub noise data measured every 1 s on the time axis for 30 seconds.

FIGS. 4B to 11B are graphs shown as the first to eighth examples of the present embodiment, respectively. In each of FIGS. 4B to 11B, the vertical axis D represents the difference (dB) based on the equivalent noise levels of the main and sub noise data, and the horizontal axis F represents the frequency (Hz). Each of FIGS. 4B to 11B shows the differences (dB) based on the equivalent noise levels of the main and sub noise data in five frequency bands having 250 Hz, 500 Hz, 1 kHz, 2 kHz, and 4 kHz as center frequencies in the 1/1 octave band, respectively.

In each of FIGS. 4B to 11B, a portion indicated by “OA” on the horizontal axis F represents the difference (dB) based on the overall value of the equivalent noise levels of the main and sub noise data. In particular, each of the graphs of FIGS. 4B to 11B shows the differences in regions of 90th percentiles or more of the equivalent noise levels (LAeq, 1 s) of the main and sub noise data for 30 seconds in the plurality of frequency bands and at the overall value.

FIGS. 4C to 11C are also graphs shown as the first to eighth examples of the present embodiment, respectively. In each of FIGS. 4C to 11C, the vertical axis M represents the MSC value m based on the equivalent noise levels of the main and sub noise data, and the horizontal axis F represents the frequency (Hz). Each of FIGS. 4C to 11C shows the MSC value m based on the equivalent noise levels of the main and sub noise data in the five frequency bands having 250 Hz, 500 Hz, 1 kHz, 2 kHz, and 4 kHz as center frequencies in the 1/1 octave band, respectively.

Furthermore, in each of FIGS. 4C to 11C, a portion indicated by “OA” on the horizontal axis F represents the MSC value m based on the overall values of the equivalent noise levels of the main and sub noise data. In particular, each of FIGS. 4C to 11C shows the MSC value m based on the average values of cross spectra and power spectra in regions of 10th percentiles or less of the equivalent noise levels (LAeq, 1 s) of the main and sub noise data for 30 seconds in a plurality of frequency bands and at the overall value.

However, FIGS. 4A to 11A, FIGS. 4B to 11B, and FIGS. 4C to 11C merely show the first to eighth examples of the present embodiment respectively, and graphs used for the time-noise comparison and/or the frequency-noise comparison are not limited to these graphs. For example, the sampling period of the equivalent noise level may be set to a time other than 1 s. Instead of the equivalent noise level, the noise level may be set to a one-shot exposure noise level, an hour rate noise level, a weighted equivalent average sensory noise level, or the like. For example, in these graphs, the recording period is set to 30 seconds, but the recording period is not limited to this time.

In the first to eighth examples of the present embodiment described above, the equivalent noise level (dB) measured for each 1 s is recorded over 30 seconds for each of the main and sub noise data in each recording period. In the first example, the second example, and the third example of the present embodiment, a bandpass filter of 200 Hz to 4 kHz is applied to the main noise data and the sub noise data.

In the first to eighth examples of the present embodiment, a plurality of frequency bands are defined by the 1/1 octave bands. However, a plurality of frequency bands can also be defined by 1/n octave bands (n is an integer of 2 or more).

### Details of Failure Diagnosing System 1

Referring to FIG. 1, the failure diagnosing system 1 can be configured in detail as follows. In the failure diagnosing system 1, the noise measuring device 20 having the noise level meter 10 constitutes a measuring station arranged around a noise measurement target. For example, the noise measuring device 20 can be arranged around an airfield, an arterial road, an expressway, a railroad, a factory, a power plant, or the like.

The failure diagnosing device 30 is arranged away from the noise measuring device 20. The failure diagnosing device 30 is configured to be communicable with the noise measuring device 20 by wireless or wired communication means. The failure diagnosing device 30 can constitute a part of a central station capable of performing monopolar management on noise data, or a part of a maintenance and inspection device used by a person in charge, a worker or the like who performs maintenance and inspection on the noise measuring device 20. However, the failure diagnosing device can also be configured integrally with the noise measuring device. The failure diagnosing device can also be arranged adjacent to the noise measuring device. In this case, the failure diagnosing device can also constitute a part of the measuring station.

### Details of the Noise Measuring Device and the Noise Level Meter Thereof

Referring to FIGS. 1 to 3, the noise measuring device 20 and the noise level meter 10 can be configured in detail as follows. As shown in FIGS. 1 to 3, the main microphone 11 of the noise level meter 10 is ECM (Electret Condenser Microphone) 11. The sub microphone 21 of the noise measuring device 20 is MEMS (Micro Electro Mechanical Systems) microphone 21.

However, the main microphone and the sub microphone are not limited to these types. For example, the main microphone may be a MEMS microphone or the like. For example, the sub microphone may be an ECM or the like. In this case, the noise measuring device may have a preamplifier for the sub microphone.

The microphone connecting member 12 serves as a preamplifier 12 which is configured to be capable of amplifying a signal from the main microphone 11. As shown in FIGS. 2 and 3, the tip portion 12a of the microphone connecting member 12 is configured to be electrically and mechanically connectable to the main microphone 11. As shown in FIG. 3, a base end portion 12c in the longitudinal direction of the microphone connecting member 12 is configured to be electrically and mechanically connectable to the main connection cable 14.

As shown in FIGS. 2 and 3, the sub microphone 21 is arranged at an intermediate portion 12d in the longitudinal direction of the microphone connecting member 12. The sub microphone 21 is also electrically and mechanically connected to a sub connection cable 15. The noise measuring device 20 has one sub microphone 21. However, the noise measuring device can also have a plurality of sub microphones. In this case, the plurality of sub microphones can be arranged to be spaced from one another in the circumferential direction of the microphone connecting member.

As shown in FIG. 1, the noise level meter 10 has a noise level meter main body 16 that is electrically connected to the main microphone 11 via the main connection cable 14 and the microphone connecting member 12. The noise level meter main body 16 includes electronic parts, electric parts, and the like for providing various functions of the noise level meter 10.

As shown in FIG. 2, the noise level meter 10 has a cover 17 which is configured to cover the main microphone 11 and the microphone connecting member 12 from the tip portion 12a side of the microphone connecting member 12. The cover 17 can also cover the sub microphone 21. The cover 17 has a mesh portion 17a which is configured to allow air to pass therethrough while preventing water and/or dust from passing therethrough.

The windscreen 13 is arranged so as to cover the cover 17 together with the main microphone 11, the sub microphone 21, and the microphone connecting member 12 from the tip portion 12a side of the microphone connecting member 12. As shown in FIG. 2, the windscreen 13 has an internal cavity 13a in which the main microphone 11, the sub microphone 21, the microphone connecting member 12, and the cover 17 can be accommodated. The windscreen 13 also has an opening 13b which is formed to open the internal cavity 13a to the outside of the windscreen 13.

As shown in FIG. 2, the noise level meter 10 has an intermediate collar 18 which is configured to support the microphone connecting member 12 from the base end portion 12c side thereof. The intermediate collar 18 has a through-hole 18a penetrating along the longitudinal direction of the microphone connecting member 12. The intermediate collar 18 supports the microphone connecting member 12c from the base end portion 12c side in a state in which the base end portion 12c of the microphone connecting member 12 and the main connection cable 14 are passed through the through-hole 18a.

As shown in FIGS. 2 and 3, the noise level meter 10 has a mounting collar 19 which is configured to support the cover 17 and the intermediate collar 18 from the base end portion 12c side of the microphone connecting member 12. The mounting collar 19 has a through-hole 19a that penetrates along the longitudinal direction of the microphone connecting member 12. The mounting collar 19 supports the cover 17 and the intermediate collar 18 from the base end portion 12c side of the microphone connecting member 12 in a state in which the main and sub connection cables 14 and 15 are passed through the through-hole 19a. The mounting collar 19 also has a slit 19b which is formed to allow the main and sub connection cables 14 and 15 to be pulled out of the noise level meter 10.

As shown in FIG. 1, the noise measuring device 20 has an audio interface 22 which is electrically connected to the main microphone 11 via the main connection cable 14, the microphone connecting member 12, and the noise level meter main body 16, and is also electrically connected to the sub microphone 21 via the sub connection cable 15. The audio interface 22 can receive signals from the main and sub microphones 11 and 21. Note that the noise level meter main body 16, particularly an audio signal output unit of the noise level meter main body 16, and the audio interface 22 are electrically connected to each other by a cable (not shown).

The noise measuring device 20 has a noise data management unit 23 which is configured to manage main and sub noise data based on signals from the main and sub microphones 11 and 21, respectively. The noise data management unit 23 is configured to receive signals from the main and sub microphones 11 and 21 via the signal audio interface 22.

The noise data management unit 23 is configured to be capable of recording main and sub noise data in a plurality of recording periods. Note that the main and sub noise data can also be recorded in the failure diagnosing device instead of the noise data management unit of the noise measuring device. Furthermore, the main and sub noise data can be recorded in the failure diagnosing device in addition to the noise data management unit of the noise measuring device.

The noise data management unit 23 is also configured to be communicable with the failure diagnosing device 30 by wireless or wired communication means. The noise data management unit 23 can be configured to include electronic components such as CPU (Central Processing Unit), RAM (Random Access Memory), ROM (Read Only Memory), a flash memory, an input interface, and an output interface, and an electric circuit in which these electronic components are arranged. Furthermore, as shown in FIG. 3, the noise measuring device 20 has a support member 24 which is configured to be capable of supporting the noise level meter 10 from below. The support member 24 is attached to the mounting collar 19 of the noise level meter 10 from below.

### Details of Failure Diagnosing Device

Referring to FIG. 1, the failure diagnosing device 30 can be configured in detail as follows. As described above, the failure diagnosing device 30 can diagnose the presence or absence of a failure of the main microphone 11 based on the noise comparison for comparing the main and sub noise data in each of a plurality of different recording periods according to elapse of time.

In the failure diagnosing device 30, it is possible to diagnose that the failure of the main microphone 11 has occurred at the time of a recording period when it is determined for the first time that there is a failure in the main microphone 11 among the plurality of recording periods. In this case, it can be determined that the main noise data in the recording periods including the recording period when it is determined for the first time that there is a failure in the main microphone 11 and the subsequent recording periods thereto have been affected by the failure, whereas it can be determined that the main noise data in the recording periods before the recording period when it is determined for the first time that there is a failure in the main microphone 11 have not been affected by the failure, and as a result, it can be effectively used.

The failure diagnosing device 30 is configured to be capable of determining whether the main and sub noise waveforms include event pulse waveforms of which noise levels are set to be higher than that of the background noise at the same time in the time-noise comparison. The failure diagnosing device 30 is configured so as to be capable of determining whether the absolute value d of the difference between the noise levels based on the event pulse waveforms of the main and sub noise waveforms is greater than the noise difference threshold value d1 in at least one of the plurality of frequency bands, and/or at the overall value in the frequency-noise comparison.

The failure diagnosing device 30 is configured to be capable of determining whether the main noise waveform includes an impact pulse waveform of which the noise level is increased more than that of the sub noise waveform at the above specific pulse width in the time-noise comparison. The failure diagnosing device 30 is configured to be capable of determining whether the MSC value m calculated from the noise data based on the background noises measured by the main and sub microphones 11 and 21 is smaller than the predetermined coherence threshold value m1 in at least one of a plurality of frequency bands, and/or at the overall value in the frequency-noise comparison.

The failure diagnosing device 30 can be configured to include electronic components such as CPU, RAM, ROM, a flash memory, an input interface, and an output interface, and an electric circuit in which such electronic components are arranged.

### Outline of Failure Diagnosing Method

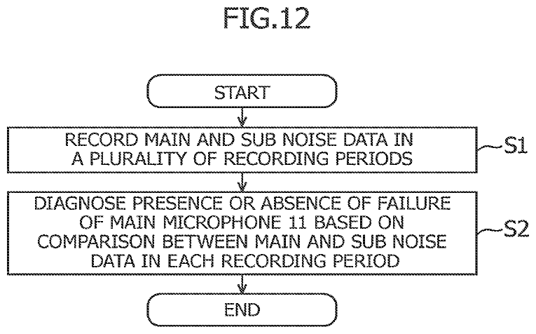

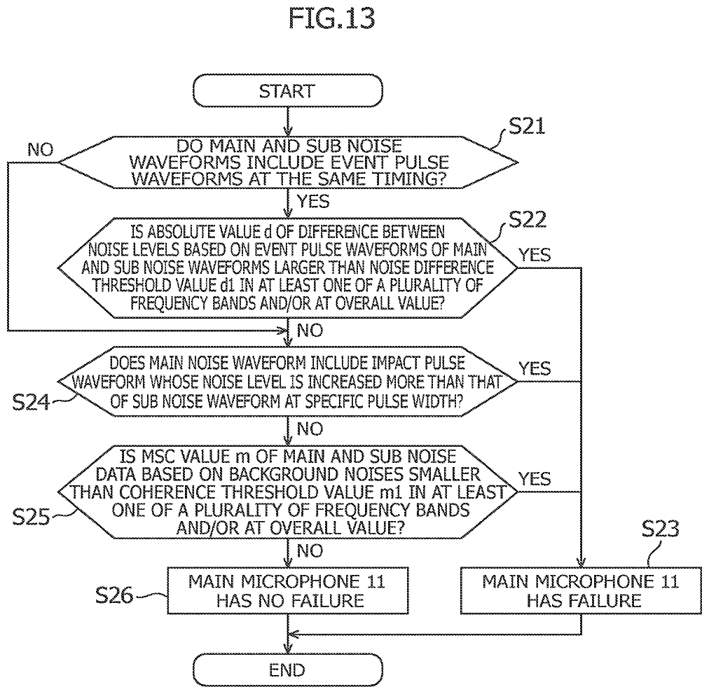

An outline of a failure diagnosing method according to the present embodiment will be described with reference to FIGS. 12 and 13. Such a failure diagnosing method is schematically configured as follows.

As shown in FIG. 12, the failure diagnosing method diagnoses a failure of the main microphone 11. In the failure diagnosing method as described above, main noise data based on noise measured by the main microphone 11 and sub noise data based on noise measured by the sub microphone 12 simultaneously with the measurement of the noise by the main microphone 11 are recorded in each of a plurality of different recording periods according to elapse of time (recording step S1). In each recording period, whether a failure of the main microphone 11 has occurred is diagnosed based on the noise comparison for comparing the main and sub noise data recorded in the recording period (failure diagnosis step S2).

In the failure diagnosis step S2 of the failure diagnosing method as described above, a noise comparison similar to that of the above failure diagnosing device 30 can be performed, and the presence or absence of a failure of the main microphone 11 can be diagnosed like the above failure diagnosing device 30.

Further referring to FIG. 13, the failure diagnosis step S2 in each recording period can be performed as follows as an example. In the time-noise comparison, it is determined whether the main and sub noise waveforms include event pulse waveforms at the same time (first stage S21 of an event noise determination step).

If the main and sub noise waveforms include event pulse waveforms at the same time (YES), it is determined whether the absolute value d of the difference between the noise levels based on the event pulse waveforms of the main and sub noise waveforms is greater than the noise difference threshold value d1 in at least one of a plurality of frequency bands, and/or at the overall value in the frequency-noise comparison (second stage S22 of the event noise determination step). If the absolute value d of the difference between the noise levels is greater than the noise difference threshold value d1 in at least one of the plurality of frequency bands, and/or at the overall value (YES), it is determined that the main microphone 11 has a failure (failure presence determination step S23).

If the absolute value d of the difference between the noise levels is equal to or less than the noise difference threshold value d1 in at least one of the plurality of frequency bands, and/or at the overall value (NO), it is determined whether the main noise waveform includes an impact pulse waveform of which the noise level is increased more than that of the sub noise waveform at the above specific pulse width in the time-noise comparison (noise determination step S24). Even if the main and sub noise waveforms do not include event pulse waveforms at the same time in the first stage S21 of the above event noise determination step (NO), it is determined whether the main noise waveform includes an impact pulse waveform in the time-noise comparison (noise determination step S24). If the main noise waveform includes an impact pulse waveform (YES), it is determined that the main microphone 11 has a failure (failure presence determination step S23).

If the main noise waveform does not include any impact pulse waveform (NO), it is determined whether the MSC value m calculated from the noise data based on the background noises measured by the main and sub microphones 11 and 21, respectively, is smaller than the coherence threshold value m1 in at least one of the plurality of frequency bands, and/or at the overall value in the frequency-noise comparison (background noise determination step S25). If the MSC value m is smaller than the coherence threshold value m1, it is determined that the main microphone 11 has a failure (failure presence determination step S23). If the MSC value m is equal to or greater than the coherence threshold value m1, it is determined that the main microphone 11 has no failure (failure absence determination step S26).

However, in the failure diagnosis step as described above, it is also possible to diagnose the presence or absence of a failure of the main microphone only by the event noise determination step, only by the noise determination step, or only by the background noise determination step. It is also possible to diagnose the presence or absence of a failure of the main microphone by a combination of two of the event noise determination step, the noise determination step, and the background noise determination step.

According to the foregoing, the noise measuring device 20 according to the present embodiment includes the noise level meter 10 having the main microphone 11 which is configured to be capable of measuring noise, and the sub microphone 21 which is configured to be capable of measuring noise simultaneously with the measurement of the noise by the main microphone 11 in order to obtain sub noise data to be compared with main noise data obtained based on the noise measured by the main microphone 11.

By using the noise measuring device 20 as described above, the main noise data based on the noise measured by the main microphone 11 and the sub noise data based on the noise measured by the sub microphone 21 are recorded in each of a plurality of sequential recording periods, and furthermore, a comparison result of the main and sub noise data recorded in each recording period is referred to, whereby it is possible to accurately determine in which one of the plurality of recording periods a failure has occurred in the main microphone 11. In particular, it is possible to accurately determine the occurrence time of the failure of the noise level meter 10 without conducting a physical inspection of the actual body of the noise level meter 10.

In the noise measuring device 20 according to the present embodiment, the noise level meter 10 includes the microphone connecting member 12 formed in an elongated shape, the main microphone 11 is arranged at the tip portion 12a in the longitudinal direction of the microphone connecting member 12, and the sub microphone 21 is arranged on the outer peripheral surface 12b of the microphone connecting member 12.

In the noise measuring device 20 as described above, the sub microphone 21 can be arranged in the vicinity of the main microphone 11, so that it is possible to enhance the correlation between the main and sub noise data based on the noises measured by the main and sub microphones 11 and 21, respectively. Therefore, it is possible to clearly detect a difference which occurs due to a problem between the main and sub noise data, so that it is possible to accurately determine in which one of the plurality of recording periods a failure of the main microphone 11 has occurred.

In the noise measuring device 20 and the failure diagnosing method according to the present embodiment, the main and sub microphones 11 and 21 are arranged inside the windscreen 13. Therefore, the main and sub microphones 11 and 21 can be placed in a similar environment, so that it is possible to enhance the correlation between the main and sub noise data based on the noises measured by the main and sub microphones 11 and 21, respectively.

The failure diagnosing system 1 according to the present embodiment includes the above noise measuring device 20 and the failure diagnosing device 30 which is configured to be capable of diagnosing a failure of the main microphone 11 of the noise level meter 10, and the failure diagnosing device 30 is configured to be capable of diagnosing the presence or absence of a failure of the main microphone 11 in each of a plurality of different recording periods based on the noise comparison for comparing the main and sub noise data recorded in the recording period according to elapse of time.

The failure diagnosing method according to the present embodiment is a failure diagnosing method for diagnosing a failure of the main microphone 11, and includes a recording step S1 for recording main noise data based on noise measured by the main microphone 11 and sub noise data based on noise measured by the sub microphone 21 simultaneously with the measurement of the noise by the main microphone 11 in each of a plurality of different recording periods according to elapse of time, and a failure diagnosis step S2 of diagnosing the presence or absence of a failure of the main microphone 11 in each recording period based on the noise comparison for comparing the main and sub noise data recorded in the recording period.

In the failure diagnosing system and the failure diagnosing method as described above, the main noise data based on the noise measured by the main microphone 11 and the sub noise data based on the noise measured by the sub microphone 21 are recorded in each of a plurality of sequential recording periods. Therefore, by referring to the comparison result between the main and sub noise data recorded in each recording period, it is possible to accurately determine in which one of the plurality of recording periods the failure of the main microphone 11 occurred. In particular, it is possible to accurately determine the time at which a failure occurred in the main microphone 11 without conducting a physical inspection of the actual body of the main microphone 11.

In the failure diagnosing system 1 and the failure diagnosing method according to the present embodiment, the noise comparison includes the time-noise comparison for comparing the main and sub noise waveforms which respectively represent the noise levels based on the noise measured by the main and sub microphones 11 and 21 respectively on the time axis, and the frequency-noise comparison for comparing the noise levels based on the noise measured by the main and sub microphones 11 and 21 respectively on the frequency axis, and it is diagnosed that the main microphone 11 has a failure when in the time-noise comparison, the main noise waveform includes an event pulse waveform of which the noise level is set to be greater than that of the background noise, whereas the sub noise waveform includes an event pulse waveform of which the noise level is set to be greater than that of the background noise at the same time as the event pulse waveform of the main noise waveform, and in the frequency-noise comparison, the absolute value d of the difference between the noise levels based on the event pulse waveforms of the main and sub noise waveforms is greater than the predetermined event noise difference threshold value d1 in at least one of the plurality of frequency bands, and/or at the overall value.

In the failure diagnosing system 1 and the failure diagnosing method as described above, it is possible to sensitively detect deterioration in sensitivity of the main microphone 11 from a change in event noise data that may be included in the main and sub noise data during a plurality of recording periods, and as a result, it is possible to accurately determine in which one of the plurality of recording periods the failure of the main microphone 11 occurred.

In the failure diagnosing system 1 and the failure diagnosing method according to the present embodiment, the noise comparison includes the time-noise comparison for comparing the main and sub noise waveforms which respectively represent the noise levels based on the noises measured by the main and sub microphones 11 and 21 respectively on the time axis, and when the main noise waveform includes an impact pulse waveform of which the noise level is increased more than that of the sub noise waveform at the pulse width of 0.1 second to 2.0 seconds in the time-noise comparison, it is diagnosed that the main microphone 11 has a failure.

In the failure diagnosing system 1 and the failure diagnosing method as described above, for example, by using a pulse noise which may be included in main noise data due to a failure of the main microphone 11 during a plurality of recording periods, it is possible to accurately determine in which one of the plurality of recording periods the failure of the main microphone 11 occurred.

In the failure diagnosing system 1 and the failure diagnosing method according to the present embodiment, the noise comparison includes the frequency-noise comparison for comparing the noise levels based on the noises measured by the main and sub microphones 11 and 21 respectively on the frequency axis, and when the MSC value m calculated from noise data based on the background noises measured by the main and sub microphones 11 and 21 respectively is smaller than the predetermined coherent threshold value m1 in at least one of a plurality of frequency bands, and/or at the overall value in the frequency-noise comparison, it is diagnosed that the main microphone 11 has a failure.

In the failure diagnosing system 1 and the failure diagnosing method as described above, by using a lot of background noise data that may be included in the main and sub noise data during a plurality of recording periods, it is possible to accurately determine in which one of the plurality of recording periods a failure of the main microphone 11 has occurred.

Although the embodiment of the present invention has been described so far, the present invention is not limited to the above-described embodiment, and the present invention can be modified and altered based on the technical concept thereof.

### EXAMPLES

Examples 1 to 8 will be described. In Examples 1 to 5, the presence or absence of a failure of the main microphone 11 was diagnosed using the above event noise determination steps S21 and S22. In Example 6, the presence or absence of a failure of the main microphone 11 was diagnosed using the above noise determination step S24. In Examples 7 and 8, the presence or absence of a failure of the main microphone 11 was diagnosed using the above background noise determination step S25.

### Examples 1 to 5

Examples 1 to 5 will be described. In the noise measuring devices 20 of each of Examples 1 to 5, the main microphone 11 of the noise level meter 10 was an ECM 11, and the sub microphone 21 of the noise measuring device 20 was an MEMS microphone 21. The sub microphone 21 was arranged on the outer peripheral surface 12b of the microphone connecting member 12, and the main and sub microphones 11 and 21 were arranged inside the windscreen 13. In Examples 1 to 5, the sensitivity of the main microphone 11 was reduced by 0.5 dB, 1.0 dB, 1.5 dB, 2.0 dB, and 2.5 dB with respect to the sensitivity of the sub microphone 21, respectively.

In each of Examples 1 to 5, the difference in noise level between the main and sub noise data was confirmed in a plurality of frequency bands and at the overall value in one recording period. One recording period was set to 30 seconds. The plurality of frequency bands were set to five frequency bands having 250 Hz, 500 Hz, 1 kHz, 2 kHz, and 4 kHz as center frequencies in the 1/1 octave band, respectively. The difference in noise level between the main and sub noise data was defined as the difference in regions of the 90th percentile or more of the equivalent noise levels (LAeq, 1 s) of the main and sub noise data.

As a result of such confirmation, graphs of FIGS. 4B to 8B relating to Examples 1 to 5 respectively could be obtained. Referring to FIGS. 4B to 8B, the foregoing difference (dB) increased in each frequency band and at the overall value as the deterioration amount in the sensitivity of the main microphone 11 with respect to the sensitivity of the sub microphone 21 was increased between 0.5 dB and 2.5 dB. In particular, this difference increased remarkably at the overall value. According to such a result, it was confirmed that if the noise difference threshold value d1 is set according to the amount of change in sensitivity to be determined as a determination material for diagnosing a failure of the main microphone 11, the presence or absence of a failure of the main microphone 11 could be diagnosed by using the above event noise determination steps S21 and S22.

### Example 6

Example 2 will be described. The noise measuring device 20 of Example 6 was the same as the noise measuring device 20 of each of Examples 1 to 5 except that the sensitivities of the main and sub microphones 11 and 21 were set the same. In Example 6, an impact pulse waveform corresponding to a pulse noise that may occur when a failure occurs in the main microphone 11 was intentionally added to the main microphone 11.

In Example 6, the main and sub noise waveforms respectively representing equivalent noise levels (LAeq, 1 s) of the main and sub noise data measured every 1 s were compared with each other on the time axis of one recording period. One recording period was set to 30 seconds.

As a result of such confirmation, a graph of FIG. 10A relating to Example 6 could be obtained. In FIG. 10A, it was clarified that the main noise data indicated by a solid line X6 included an impact pulse waveform, whereas the sub noise data indicated by a broken line Y6 did not include an impact pulse waveform. According to such a result, it was confirmed that the presence or absence of a failure of the main microphone 11 could be diagnosed using the above noise determination step S24.

### Examples 7 and 8

Examples 7 and 8 will be described. The noise measuring device 20 of each of Examples 7 and 8 was the same as the noise measuring device 20 of each of Examples 1 to 5 except that the sensitivities of the main and sub microphones 11 and 21 were set to the same. In Example 7, the same pink noise of 50 dB was added to the noises measured by the main and sub microphones 11 and 21, respectively. In Example 8, different pink noises of 60 dB were added to the noises measured by the main and sub microphones 11 and 21, respectively.

In each of Examples 7 and 8, the MSC value m based on the main and sub noise data was confirmed in a plurality of frequency bands and at the overall value in one recording period. One recording period was set to 30 seconds. The plurality of frequency bands were set to five frequency bands having 250 Hz, 500 Hz, 1 kHz, 2 kHz, and 4 kHz as center frequencies in the 1/1 octave band, respectively. The MSC value m based on the main and sub noise data was set to the MSC value m based on the average values of the cross spectrum and the power spectrum in the regions of the 10th percentile or less of the equivalent noise levels (LAeq, 1 s) of the main and sub noise data.

As a result of such confirmation, graphs of FIGS. 10C and 11C relating to Examples 7 and 8 respectively could be obtained. Referring to FIGS. 10C and 11C, the MSC value m of Example 8 was smaller than the MSC value m of Example 7 in each frequency band and at the overall value. According to such a result, it could be confirmed that if the coherence threshold value m1 was set in consideration of the variation or the like of the MSC value m calculated from the noise data based on the background noises confirmed by the main and sub microphones 11 and 21 respectively in the normal state, the presence or absence of a failure of the main microphone 11 could be diagnosed by using the above background noise determination step S25.

### REFERENCE SIGNS LIST

1 . . . Failure diagnosing system, 10 . . . Noise level meter, 11 . . . Main microphone, 12 . . . Microphone connecting member, 12a . . . Tip portion, 12b . . . Outer peripheral surface, 13 . . . Windscreen, 20 . . . Noise measuring device, 21 . . . Sub microphone, 30 . . . Failure diagnosing device

d . . . Absolute value of the difference between the noise levels based on the event pulse waveforms of the main and sub noise waveforms, d1 . . . Noise difference threshold value

m . . . Magnitude-squared coherence value (MSC value), m1 . . . Coherence threshold value

S1 . . . Recording step, S2 . . . Failure diagnosis step

1. A failure diagnosing method for diagnosing a failure of a main microphone comprising:
a recording step of recording main noise data based on noise measured by the main microphone and sub noise data based on noise measured by a sub microphone simultaneously with the measurement of the noise by the main microphone in each of a plurality of different recording periods according to elapse of time; and
a failure diagnosis step of diagnosing presence or absence of a failure of the main microphone in each recording period based on a noise comparison for comparing the main and sub noise data recorded in the recording period.

2. The failure diagnosing method according to claim 1, wherein the noise comparison includes a time-noise comparison for comparing main and sub noise waveforms which respectively represent noise levels based on the noise measured by the main and sub microphones respectively on a time axis, and a frequency-noise comparison for comparing noise levels based on the noises measured by the main and sub microphones on a frequency axis, and
it is diagnosed that the main microphone has a failure when in the time-noise comparison, the main noise waveform includes an event pulse waveform of which the noise level is set to be greater than that of a background noise, whereas the sub noise waveform includes an event pulse waveform of which the noise level is set to be greater than that of a background noise at the same time as the event pulse waveform of the main noise waveform, and in the frequency-noise comparison, an absolute value of a difference between the noise levels based on the event pulse waveforms of the main and sub noise waveforms is greater than a predetermined noise difference threshold value in at least one of a plurality of frequency bands, and/or at an overall value.

3. The failure diagnosing method according to claim 1, wherein the noise comparison includes a time-noise comparison for comparing main and sub noise waveforms which respectively represent noise levels based on the noises measured by the main and sub microphones respectively on a time axis, and
it is diagnosed that the main microphone has a failure when the main noise waveform includes an impact pulse waveform of which the noise level is increased more than the sub noise waveform at a pulse width of 0.1 second to 2.0 seconds in the time-noise comparison.

4. The failure diagnosing method according to claim 1, wherein the noise comparison includes a frequency-noise comparison for comparing noise levels based on the noise measured by the main and sub microphones respectively on a frequency axis, and
it is diagnosed that the main microphone has a failure when a magnitude-squared coherence value calculated from noise data based on background noises measured by the main and sub microphones respectively is smaller than a predetermined coherence threshold value in at least one of a plurality of frequency bands, and/or at an overall value in the frequency-noise comparison.

5. The failure diagnosing method according to claim 1, wherein the main and sub microphones are arranged inside a windscreen.

6. A noise measuring device comprising:
a noise level meter including a main microphone configured to be capable of measuring noise; and
a sub microphone configured to be capable of measuring noise simultaneously with the measurement of the noise by the main microphone in order to obtain sub noise data to be compared with main noise data obtained based on the noise measured by the main microphone.

7. The noise measuring device according to claim 6, wherein the noise level meter includes a microphone connecting member formed in an elongated shape, the main microphone is arranged at a tip portion in a longitudinal direction of the microphone connecting member, and the sub microphone is arranged on an outer peripheral surface of the microphone connecting member.

8. The noise measuring device according to claim 6, further comprising a windscreen in which the main and sub microphones are arranged.

9. A failure diagnosing system comprising:
the noise measuring device according to claim 6; and
a failure diagnosing device configured to be capable of diagnosing a failure of the main microphone of the noise level meter, wherein the failure diagnosing device is configured to be capable of diagnosing presence or absence of a failure of the main microphone in each of a plurality of different recording periods according to elapse of time based on noise comparison for comparing the main and sub noise data recorded in the recording period.

10. The failure diagnosing system according to claim 9, wherein the noise comparison includes a time-noise comparison for comparing main and sub noise waveforms which respectively represent noise levels based on noise measured by the main and sub microphones respectively on a time axis, and a frequency-noise comparison for comparing the noise levels based on the noise measured by the main and sub microphones respectively on a frequency axis, and
it is diagnosed that the main microphone has a failure when in the time-noise comparison, the main noise waveform includes an event pulse waveform whose noise level is set to be greater than that of a background noise, whereas the sub noise waveform includes an event pulse waveform of which the noise level is set to be greater than that of a background noise at the same time as the event pulse waveform of the main noise waveform, and in the frequency-noise comparison, an absolute value of a difference between the noise levels based on the event pulse waveforms of the main and sub noise waveforms is greater than a predetermined noise difference threshold value in at least one of a plurality of frequency bands, and/or at an overall value.

11. The failure diagnosing system according to claim 9, wherein the noise comparison includes a time-noise comparison for comparing main and sub noise waveforms which respectively represent noise levels based on noise measured by the main and sub microphones respectively on a time axis, and
it is diagnosed that the main microphone has a failure when the main noise waveform includes an impact pulse waveform of which the noise level is increased more than that of the sub noise waveform at a pulse width of 0.1 second to 2.0 seconds in the time-noise comparison.

12. The failure diagnosing system according to claim 9, wherein the noise comparison includes a frequency-noise comparison for comparing noise levels based on noise measured by the main and sub microphones respectively on a frequency axis, and
it is diagnosed that the main microphone has a failure when a magnitude-squared coherence value calculated from noise data based on background noises measured by the main and sub microphones respectively is smaller than a predetermined coherence threshold value in at least one of a plurality of frequency bands, and/or at an overall value in the frequency-noise comparison.
